(19) United States
(12) Patent Application Publication
(10) Pub. No.: US 2011/0248694 A1
(43) Pub. Date: Oct. 13, 2011

(54) SOFT SWITCHING APPARATUS, METHOD, AND POWER CONVERSION SYSTEM

(76) Inventors: Chun-Kong CHAN, Hsin Chuang City (TW); Po-Yuan Yu, Hsin Chuang City (TW)

(21) Appl. No.: 12/755,659

(22) Filed: Apr. 7, 2010

(51) Int. Cl. G05F 1/10

(52) U.S. Cl. 323/282

(57) ABSTRACT

Soft switching apparatus, method, and power conversion system are disclosed. The apparatus includes a main switching unit and a buffer unit for adjusting a voltage level of a switching signal, in order to change an internal resistance of the main switching unit and to reduce the sudden change to a voltage and a current flowing through the main switching unit.

### BACKGROUND OF THE INVENTION

1. Field of the Invention

The present invention relates to a switching apparatus, and more particularly, to a soft switching apparatus, method, and application in a power conversion system.

2. Description of the Related Art

In the conventional multiple-output power converter, every power output should be associated with a switching unit before more than one power output could be outputted or stopped from being outputted at the same time. Therefore, as the number of power outputs increases, more and more switching units are needed to achieve the same goal. However, the power consumption and cost of the multiple-output power converter would increase with the number of the switching units increasing.

Additionally, for stabilizing the outputted power of the multiple-output power converter, a linear regulator is installed for every switching unit, in order to avoid circuit damage caused by sudden change to the voltage and the current (e.g., voltage/current spike). Thus, when more and more linear regulators are required, the total cost for the manufacturing of the power converter and the power consumption would go much higher.

### SUMMARY OF THE INVENTION

Because of the aforementioned problems, the present invention provides a switching apparatus at the secondary coil of a power conversion unit in order to simultaneously control an output of at least one power output. Additionally, the present invention also provides soft switching mechanism for reducing voltage and current variations when the switching unit is switched on.

For achieving the mentioned purposes, according to the present invention, a soft switching apparatus is disclosed. The apparatus includes a main switching unit and a buffer unit. The main switching unit has an input end and an output end and is conducted or turned off by a switching signal. The buffer unit is coupled with the main switching unit, for reducing the voltage and current variations of an output end of the main switching unit.

Specifically, when the main switching unit switches between states of being conducted and turned off, the buffer unit adjusts a voltage level of the switching signal, which controls an internal resistance of the main switching unit, so as to reduce the voltage and current variations of the output end of the main switching unit. Alternatively, the buffer unit can be in a parallel connection with the main switching unit.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a block diagram of a soft switching apparatus according to one embodiment of the present invention;

FIG. 2 is a circuit diagram of a soft switching apparatus according to one embodiment of the present invention;

FIG. 3 is a circuit diagram of a power conversion system according to one embodiment of the present invention;

FIG. 4 is a circuit diagram of secondary coils of the power conversion system according to one embodiment of the present invention;

FIG. 5 is a flow chart of a soft switching method according to one embodiment of the present invention; and

FIG. 6 is a schematic diagram of a soft switching apparatus according to one embodiment of the present invention.

### DETAILED DESCRIPTION OF THE PREFERRED EMBODIMENTS

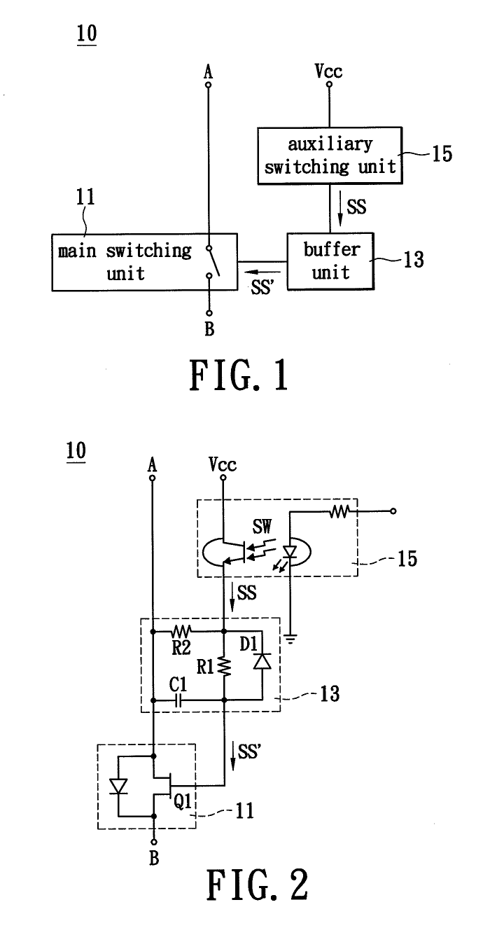

Please refer to FIG. 1, which is a block diagram of a soft switching apparatus 10 according to one embodiment of the present invention. The soft switching apparatus 10 includes a main switching unit 11, a buffer unit 13, and an auxiliary switching unit 15. The soft switching unit 10 causes the main switching unit 11 to be conducted or turned off so that the buffer unit 13 may reduce voltage and current variations of point B. In this embodiment, the buffer unit 13 adjusts a voltage level of the switching signal SS, which is for indicating whether to conduct or turn off the main switching unit 11, and generates the modulated switching signal SS′ for controlling an internal resistance of the main switching unit 11. Thus, when the main switching unit 11 switches between states of being conducted and turned off, the voltage and current variations of point B can be reduced.

Specifically, the main switching unit 11 can be an electrical switch such as a transistor. The internal resistance of the transistor may vary according to the voltage level of a driving signal such as the modulated switching signal SS′. For example, when the voltage of a driving signal goes up, the internal resistance of the transistor will decrease. And, on the other hand, when the voltage of the driving signal decreases the internal resistance of the transistor will increase.

Accordingly, when the voltage level of the received switching signal SS changes from a low voltage level to a high voltage level (i.e., the received switching signal SS is for conducting the main switching unit 11), the buffer unit 13 may modulate the voltage level of the received switching signal SS in response to the sudden increase in the voltage level of the switching signal SS. Thus, the modulated switching signal SS′ may be a gradually increasing voltage signal.

Thus, when the voltage level of the modulated switching signal SS′ is at a conducting voltage level to conduct the main switching unit 11, since that particular voltage level is still relatively low compared with the voltage level associated with the original switching signal SS, the internal resistance of the main switching unit 11 is relatively high when compared with the internal resistance induced by the original switching signal SS. Therefore, because of the relatively high internal resistance, the voltage and the current variation at point B may remain as desired.

Thereafter, the voltage level of the modulated switching signal SS′ may gradually climb a desired voltage level, and the internal resistance of the main switching unit 11 may gradually return to its normal value. Under this arrangement, the voltage and the current variation at point B may not be too significant especially at the moment when the main switching unit 11 is conducted.

On the other hand, when the voltage level of the received switching signal SS changes from the high voltage level to the low voltage (i.e., the received switching signal SS is for turning off the main switching unit 11), the buffer unit 13 may modulate the voltage level of the received switching signal SS in response to the sudden decrease in the voltage level of the received switching signal SS. And the modulated switching signal SS′ may be a gradually decreasing voltage signal.

During the period when the voltage level of the modulated switching signal SS′ decreases, the internal resistance of the main switching unit 11 increases gradually in order to gradually decrease the voltage and current passing through the main switching unit 11, so that the voltage level of the modulated switching signal SS′ is gradually lowered to a point where the main switching unit 11 could not be conducted anymore.

Moreover, the soft switching apparatus can further include an auxiliary switching unit 15 for controlling the voltage of the switching signal SS from the low voltage level to the high voltage level, and vise versa.

Please refer to FIG. 2, which is a circuit diagram of a soft switching apparatus 10 according to one embodiment of the present invention. The apparatus 10 includes a main switching unit 11, a buffer unit 13, and an auxiliary switching unit. The main switching unit 11 has a transistor Q1 for controlling a signal transmission between points A and B.

As shown in FIG. 2, before the main switching unit 11 to be conducted, the auxiliary switching unit 15 may conduct a photo coupler SW for a generation of the switching signal SS of a high voltage level. The switching signal SS goes through a charge path of the buffer unit 13, which include a resistor R1 and a capacitor C1.

At the beginning of the charging, the capacitor C1 has nearly no energy stored, so most of the energy of the switching signal SS is used to charge the capacitor C1, and just a small portion of the energy (the modulated switching signal SS′ as shown in FIG. 2) is used to drive transistor Q1. And because of the relatively low voltage level of the modulated switching signal SS′, the induced internal resistance of the transistor Q1 is relatively high. The high internal resistance of transistor Q1 may reduce the voltage and current variation at point B.

Since the capacitor C1 is getting to be fully charged as the photo coupler SW continues to be conducted, the modulated switching signal SS′ sent to the transistor Q1 increases. And with the increasing modulated switching signal SS′, the internal resistance of the transistor Q1 decreases so that the voltage and the current flow passing through the transistor Q1 may gradually return to normal.

On the other hand, when the main switching unit 11 is to be turned off the auxiliary switching unit 15 may turn off the photo coupler SW in order to generate the switching signal SS of the low voltage level. Since the capacitor C1 is fully charged at this point, the energy of the modulated switching signal SS′ is provided by the capacitor C1. The energy of the capacitor C1 passes through a discharge path of the buffer unit 13, which includes a diode D1 and another resistor R2. Thus, the voltage level of the modulated switching signal SS′ may gradually decrease, increasing the internal resistance of the transistor Q1 accordingly. Thus, the voltage and current flow through the transistor Q1 (i.e., at point B) also decrease gradually until the gradually decreased voltage level of the switching signal SS′ is not sufficient enough to turn on the transistor Q1.

Therefore, according to the above discussions, the length of the conducting time (the time for the capacitor C1 to be fully charged) or the length of the turn-off time (the time capacitor C1 requires to be fully discharged) of the main switching unit 11 can be determined by the values of the resistors R1, and R2, and the capacitor C1. In one implementation, the resistance of the resistor R1 and R2 can be of an identical value, so that the conducting time and the turn-off time of the main switching unit 11 could be the same.

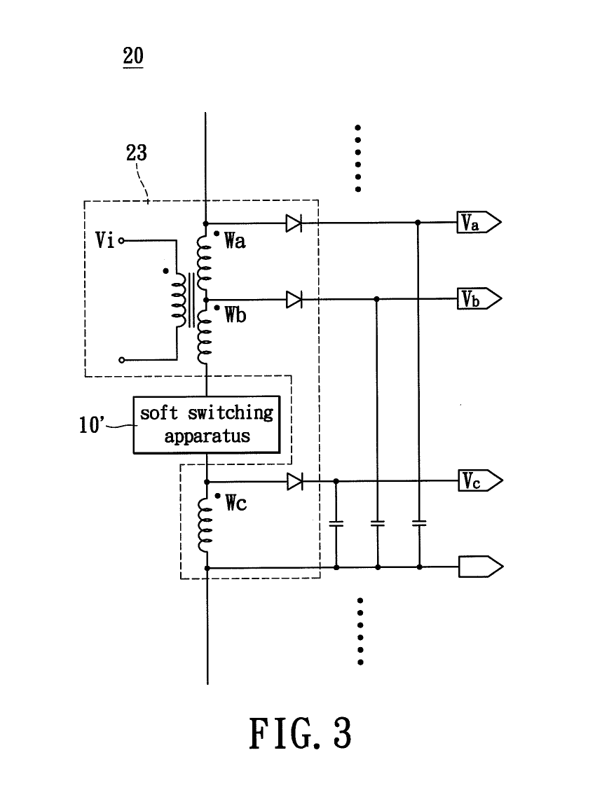

Please refer to FIG. 3, which is a circuit diagram of a power conversion system 20 according to one embodiment of the present invention. The system 20 includes a power conversion unit 23 with multiple power outputs Va, Vb, and Vc, which is induced from a power input Vi by secondary coils Wa, Wb, and Wc, respectively. And a soft switching apparatus 10′ is coupled with the secondary coils of the power conversion unit 23.

As shown in FIG. 3, the power conversion system 20 may control whether to output the power outputs Va and Vb simultaneously by conducting or turning off the soft switching apparatus 10′. And the location of the soft switching apparatus 10′ determines which power outputs could be turned on or off at the same time. In the embodiment shown in FIG. 3, the soft switching apparatus 10′ is placed between the secondary coils of Wa and Wb and the secondary coil Wc. Under this arrangement, the power outputs Va and Vb could be simultaneously delivered to outside. It is worth noting that the multiple power outputs can be controlled by just one switching apparatus according to the present invention, decreasing the manufacturing cost for the power conversion system while maintaining the capability of outputting multiple power outputs.

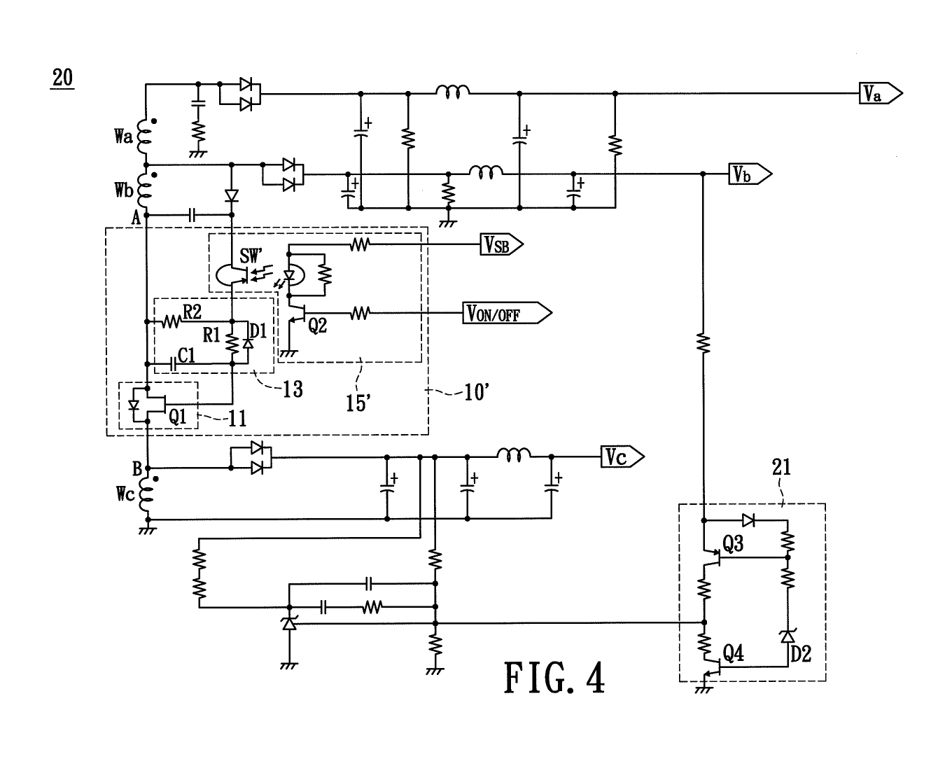

Please refer to FIG. 4, which is a secondary side circuit diagram of a power conversion system 20 according to one embodiment of the present invention. The secondary coils Wa, Wb, and Wc are for generating the power outputs Va, Vb, and Vc, respectively. The power conversion system 20 includes a soft switching apparatus 10′ having a main switching unit 11, a buffer unit 13, and an auxiliary switching unit 15′. And the soft switching apparatus 10′ is placed between the secondary coils Wa and Wb and the secondary coil Wc, for simultaneously conducting or turning off the power outputs Va and Vb.

The auxiliary switching unit 15′ has two voltage inputs, V_{SB} and V_{ON/OFF}. The voltage input V_{SB} is for providing a power to a light emitting part of a photo coupler SW′, and the voltage input V_{ON/OFF} is for controlling a transistor Q2. In this embodiment, when the voltage inputs V_{SB} and V_{ON/OFF} are at high voltage levels at the same time the photo coupler SW′ is turned on. And therefore the high-level voltage passes through the photo coupler SW′ to the buffer unit 13, and charges a capacitor C1.

At the beginning of the capacitor charging, most of the energy is used to charge the capacitor C1 so that the switching driving signal, which is used to drive transistor Q1, is relatively low. And because of the relatively low voltage level of the switching signal, the induced internal resistance of the transistor Q1 is relatively high, so as to reduce the voltage and current variation of the transistor Q1. After that, the switching driving signal, which is sent to the transistor Q1, gradually increases after the capacitor C1 approaches a fully-charged state. And with the increasing switching driving signal, the internal resistance of the transistor Q1 decreases, so that the voltage and current flow of the transistor Q1 may gradually return to its normal value.

And when the photo coupler SW′ is turned off, the switching driving signal is at low voltage level. Since the capacitor C1 is fully charged at that moment, the energy of switching signal provided by the capacitor C1 would be thereafter consumed by a resistor R2 via a diode D1. With the gradually decreasing voltage level of the switching signal, the internal resistance of the transistor Q1 increases gradually. Thus, the voltage and the current flow through the transistor Q1 would decrease gradually until the voltage level of the switching signal is insufficient to conduct the transistor Q1.

Additionally, a feedback stabilization unit 21 can be installed at feedback circuitry between the power outputs Vb and Vc of the power conversion system 20, for minimizing a fluctuation in voltage at the power output Vc caused by a feedback of the power output Vb. The feedback stabilization unit 21 has two transistors Q3 coupled to the power output Vb and Q4 connected to a ground, and a Zener diode D2.

During a feedback operation, the transistors Q3 and Q4 are turned on at the same time, causing a feedback of only a predetermined portion of the power output Vb without affecting the power output Vc and minimizing the fluctuation in the voltage level thereof. The Zener diode D2 is to determine whether the power output Vb is large enough to conduct the transistors Q3 and Q4 at the same time. More specifically, when the Zener diode D2 detects that the power output Vb is larger than a predetermined value since the soft switching apparatus 10′ is conducted, the Zener diode D2 then conducts the transistor Q3 and Q4 at the same time to enable the feedback of the power output Vb. Otherwise, the transistors Q3 and Q4 may be turned off.

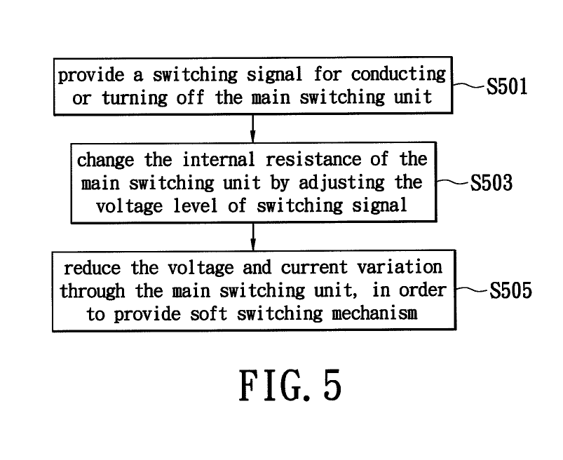

Please refer to FIG. 5, which is a flow chart of a soft switching method according to one embodiment of the present invention. The method includes: providing a switching signal for conducting or turning off the main switching unit 11 (S501), adjusting the voltage level of the switching signal when the main switching unit 11 switches between being conducted and turned off, for modulating an internal resistance of the main switching unit 11 (S503), and reducing a voltage and current variation at an output end of the main switching unit 11, so as to provide soft switching mechanism (S505).

Specifically, the voltage level of the switching signal is adjusted by a buffer unit 13. And the main switching unit 11 can be installed at a secondary side so as to simultaneously deliver multiple power outputs coupled to the secondary coils.

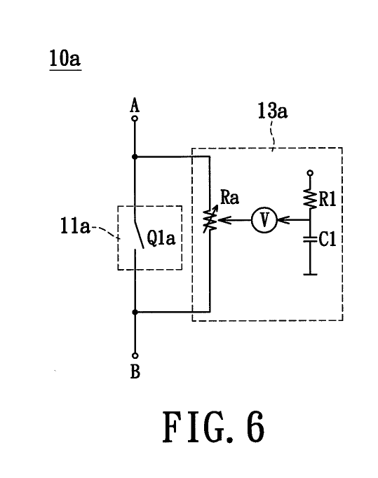

Please refer to FIG. 6, which is a schematic diagram of a soft switching apparatus 10a according to one embodiment of the present invention. The apparatus 10a has a buffer resistor Ra, a resistor R1, and a capacitor C1. Similarly, through a charge and discharge implemented by the presence of the resistor R1 and the capacitor C1, a voltage V may be generated for controlling a resistance of the buffer resistor Ra.

Before the transistor Q1a is turned on, the resistance of the buffer resistor Ra may be adjusted so as the voltage and the current transmitted from point A to point B could gradually increase. And when the voltage and the current of point A is large enough to conduct the main switching unit 11a the voltage and current variation at point B of the main switching unit 11a may be reduced and stabilized.

As described above, the present invention provides a switching apparatus at the secondary coils of the power converter, for turning on/off multiple power outputs at the same time. Further, the switching apparatus also has soft switching mechanism for reducing the voltage and current variations. Therefore, according to present invention, the efficiency of the power converter can be improved, and the cost of the power converter can be reduced.

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. A soft switching apparatus, comprising:
a main switching unit, controlled by a switching signal, having an input end and an output end; and
a buffer unit coupling with the main switching unit, for reducing voltage and current variations of the output end.

2. The soft switching apparatus as in claim 1, wherein the buffer unit adjusts a voltage level of the switching signal for changing an internal resistance of the main switching unit, so as to reduce the voltage and current variations of the output end of the main switching unit.

3. The soft switching apparatus as in claim 2, wherein the buffer unit includes a charge path and a discharge path, for adjusting the voltage level of the switching unit.

4. The soft switching apparatus as in claim 3, wherein the charge path and the discharge path both have at least one resistor and at least one capacitor.

5. The soft switching apparatus as in claim 1, further comprising:
an auxiliary switching unit coupling with the buffer unit, for controlling whether to provide the switching signal or not.

6. The soft switching apparatus as in claim 1, wherein the buffer unit includes a buffer resistor which in a parallel connection with the main switching unit.

7. The soft switching apparatus as in claim 6, wherein the buffer resistor reduces the voltage and current variations of the output end before the main switching unit is conducted by the switching signal.

8. A power conversion system, comprising:
a power conversion unit having at least one secondary coil;
a soft switching apparatus coupling with the secondary coils of the power conversion unit, for simultaneously conducting or turning off one or more secondary coils, in which the soft switching apparatus includes:
a main switching unit, controlled by a switching signal, having an input end and an output end; and
a buffer unit coupling with the main switching unit, for reducing voltage and current variations of the output end.

9. The power conversion system as in claim 8, wherein the buffer unit adjusts a voltage level of the switching signal for changing an internal resistance of the main switching unit, so as to reduce the voltage and current variations of the output end of the main switching unit.

10. The power conversion system as in claim 9, wherein the buffer unit includes a charge path and a discharge path, for adjusting the voltage level of the switching unit, and the charge path and the discharge path both have at least one resistor and at least one capacitor.

11. The power conversion system as in claim 8, wherein the soft switching apparatus further includes an auxiliary switching unit coupled with the buffer unit, for controlling whether to provide the switching signal or not.

12. The power conversion system as in claim 8, wherein the buffer unit includes a buffer resistor in a parallel connection with the main switching unit.

13. The power conversion system as in claim 12, wherein the buffer resistor reduces the voltage and current variations of the output end before the main switching unit is conducted by the switching signal.

14. A soft switching method, comprising:
conducting or turning off a main switching unit according to a switching signal, in which the main switching unit has an input end and an output end; and
reducing voltage and current variations of the output end of the main switching unit by a buffer unit, when the main switching unit switching between states of being conducted and turned off.

15. The soft switching method as in claim 14, wherein the step of reducing the voltage and current variations of the output end, includes adjusting a voltage level of the switching signal for changing an internal resistance of the main switching unit.

16. The soft switching method as in claim 15, wherein the buffer unit has a charge path and a discharge path, for changing the voltage level of the switching signal.

17. The soft switching method as in claim 14, wherein the switching signal is controlled by an auxiliary switching unit.

18. The soft switching method as in claim 14, wherein the buffer unit includes a buffer resistor in a parallel connection with the main switching unit.

19. The soft switching method as in claim 18, wherein the buffer resistor reduces the voltage and current variations of the output end before the main switching unit is conducted by the switching signal.

20. The soft switching method as in claim 14, wherein the main switching unit is coupled with at least one secondary coil of a power conversion unit, for simultaneously conducting or turning off one or more of the secondary coils.
